(19) United States
(12) Patent Application Publication
(10) Pub. No.: US 2025/0080199 A1
(43) Pub. Date: Mar. 6, 2025

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventor: Jianfei CAO, Beijing (CN)

(73) Assignee: Sony Group Corporation, Tokyo (JP)

(21) Appl. No.: 18/726,419

(22) PCT Filed: Jan. 5, 2023
(86) PCT No.: PCT/CN2023/070610

§ 371 Date: Jul. 3, 2024

(30) Foreign Application Priority Data
Jan. 12, 2022 (CN) 202210032005.7

(51) Int. Cl. H04B 7/06

(52) U.S. Cl. CPC H04B 7/06952; H04B 7/0626

(57) ABSTRACT

The present disclosure provides an electronic device and method for wireless communication, and a computer readable storage medium. The electronic device comprises: a processing circuit, configured to: determine that a physical layer beam management event occurs; and execute a beam management process initiated by a user equipment.

This application claims priority to Chinese Patent Application No. 202210032005.7 titled “ELECTRONIC DEVICE AND METHOD FOR WIRELESS COMMUNICATION, AND COMPUTER-READABLE STORAGE MEDIUM”, filed on Jan. 12, 2022 with the China National Intellectual Property Administration (CNIPA), which is incorporated herein by reference in its entirety.

### FIELD

The present disclosure relates to the technical field of wireless communications, and particularly to beam management technology. More specifically, the present disclosure relates to an electronic apparatus and a method for wireless communications and a computer-readable storage medium.

### BACKGROUND

According to the current 3GPP NR protocol, a beam management procedure, such as downlink beam measurement and beam reporting of user equipment (UE) and a beam indication to UE by a network side (NW), is completed under the control of the NW. This allows the NW to take control of wireless resources from an overall perspective. However, the NW cannot know in advance about some problems related to a spatial beam, such as problems that a beam is no longer applicable due to movement and rotation of the UE, or a certain antenna panel of the UE has an excessive emission.

To solve the aforementioned problem, it is expected to provide an improved beam management technology.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry, configured to: determine that a physical layer beam management event has occurred; and perform a beam management procedure initiated by user equipment.

According to another aspect of the present disclosure, a method for wireless communications is provided. The method includes: determining that a physical layer beam management event has occurred; and performing a beam management procedure initiated by user equipment.

According to an aspect of the present disclosure, an electronic apparatus for wireless communications is provided. The electronic apparatus includes processing circuitry, configured to: receive indication information in a beam management procedure initiated by user equipment; and perform beam management operations in response to the indication information.

According to another aspect of the present disclosure, a method for wireless communications is provided. The method includes: receiving indication information in a beam management procedure initiated by user equipment; and performing beam management operations in response to the indication information.

According to other aspects of the present disclosure, computer program codes and a computer program product for implementing the above-described method for wireless communications and a computer-readable storage medium having the computer program codes for implementing the above-described method for wireless communications stored thereon are further provided.

With the electronic apparatus and method according to the embodiments of the present disclosure, the beam management can be performed in response to occurrence of the physical layer beam event through the beam management procedure initiated by UE. Thereby, a latency caused by the beam management procedure can be reduced and communication quality can be improved.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 is a block diagram illustrating functional modules of an electronic apparatus for wireless communications according to an embodiment of the present disclosure;

FIG. 2 illustrates a schematic diagram of an example of a process of downlink beam sweeping initiated by UE;

FIG. 3 illustrates a schematic diagram of an example of a process of uplink beam sweeping initiated by UE;

FIG. 4 illustrates a schematic diagram of a DMRS accompanying a PDSCH;

FIG. 5 illustrates another schematic diagram of a DMRS accompanying a PDSCH;

FIG. 6 illustrates a schematic diagram of signaling related to power setting;

FIG. 7A illustrates an example of reporting an ID of a SSB or CSI-RS included in a TCI state corresponding to a DMRS;

FIG. 7B illustrates an example of reporting a TCI state ID corresponding to a DMRS;

FIG. 8 illustrates a schematic example of signaling related to beam activation or beam selecting initiated by UE;

FIG. 9 illustrates another schematic example of signaling related to beam activation or beam selecting initiated by UE;

FIG. 10 illustrates another schematic example of signaling related to beam activation or beam selecting initiated by UE;

FIG. 11 is a block diagram illustrating functional modules of an electronic apparatus for wireless communications according to another embodiment of the present disclosure;

FIG. 12 shows a flowchart of a method for wireless communications according to an embodiment of the present disclosure;

FIG. 13 shows a flowchart of a method for wireless communications according to an embodiment of the present disclosure;

FIG. 14 is a block diagram showing a first example of an exemplary configuration of an eNB or gNB to which the technology of the present disclosure may be applied;

FIG. 15 is a block diagram showing a second example of an exemplary configuration of an eNB or gNB to which the technology of the present disclosure may be applied;

FIG. 16 is a block diagram showing an example of an exemplary configuration of a smartphone to which the technology according to the present disclosure may be applied;

FIG. 17 is a block diagram showing an example of an exemplary configuration of a car navigation apparatus to which the technology according to the present disclosure may be applied; and

FIG. 18 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

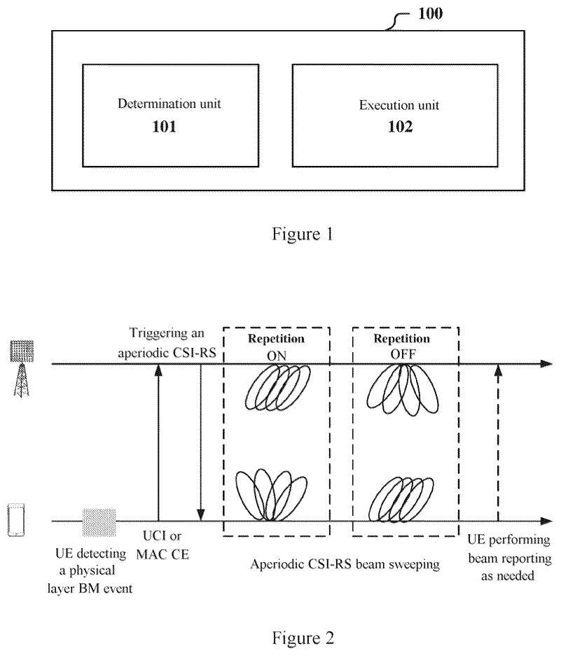

FIG. 1 illustrates a block diagram of functional modules of an electronic apparatus 100 for wireless communications according to an embodiment of the present disclosure. As shown in FIG. 1, the electronic apparatus 100 includes: a determination unit 101 configured to determine that a physical layer beam management event has occurred; and an execution unit 102 configured to perform a beam management procedure initiated by UE.

The determination unit 101 and the execution unit 102 may be implemented by one or more processing circuits. The processing circuitry may be implemented as a chip or a processor, for example. It should be understood that various functional units in the electronic apparatus shown in FIG. 1 are only logical modules divided based on specific functions thereof, and are not for limiting a specific implementation. This also applies to examples of other electronic apparatus to be described later.

The electronic apparatus 100 may, for example, be provided on UE side or be communicatively connected to the UE. Here, it should be noted that the electronic apparatus 100 may be implemented at a chip level or at a device level. For example, the electronic apparatus 100 may operate as the UE itself and may further include a memory, a transceiver (not shown), and other external devices. The memory may store programs that the user equipment needs to execute to achieve various functions and related data information. The transceiver may include one or more communication interfaces to support communications with different devices (such as a base station, another UE, and the like). An implementation of the transceiver is not specifically limited here.

For example, the determination unit 101 may determine that a physical layer (L1) beam management (BM) event has occurred based on measurement of a reference signal performed by the UE. Specifically, the determination unit 101 may determine an occurrence of a physical layer BM event in a case that quality of a reference signal measured by the UE drops below a predetermined level, or which is equivalent to that a previous measurement value drops by a predetermined value (such as 9 dB or 12 dB).

Alternatively, the determination unit 101 may detect a movement or a change in orientation of the UE by using a sensor on the UE, preliminarily determine that the previous beam may no longer be applicable, and thereby determine that a physical layer BM event has occurred.

In a case that it is determined by the determination unit 101 that a physical layer BM event has occurred, the execution unit 102 performs a beam management procedure initiated by the UE. In the present disclosure, being initiated by the UE may also be referred to as being triggered by the UE or being initialized by the UE, and these expressions all represent similar meanings, i.e., the UE plays an active role in the beam management procedure.

For example, the beam management procedure initiated by the UE includes any one or more of the following: beam sweeping initiated by the UE, beam reporting initiated by the UE, beam activation initiated by the UE, and beam selecting initiated by the UE. Examples of the beam management procedures initiated by the UE are described below.

### Beam Sweeping Initiated by the UE

In a case of beam sweeping initiated by the UE, the UE actively requests a network side to perform or allow aperiodic beam sweeping to find an appropriate downlink or uplink emission beam. The network side in the present disclosure is, for example, a base station. For example, the execution unit 102 may request the network side to trigger the beam sweeping initiated by the UE via Uplink Control Information (UCI) or MAC CE. The UCI may be included in a Physical Uplink Control Channel (PUCCH) or Physical Uplink Shared Channel (PUSCH). The MAC CE may be included in the PUSCH.

The execution unit 102 may request the network side to trigger downlink beam sweeping initiated by the UE via UCI or MAC CE. In a case that the execution unit 102 includes, via the UCI, information for triggering the downlink beam sweeping, the UCI includes information indicating an activated CSI-AperiodicTriggerState, that is, the UCI points to an aperiodic CSI-RS resource set of the activated CSI-AperiodicTriggerState. The CSI-AperiodicTriggerState is suggested by the UE, for example. Then, the network side triggers the aperiodic CSI-RS beam sweeping via Downlink Control Information (DCI).

In a case that the execution unit 102 includes, via the MAC CE, information for triggering downlink beam sweeping, the MAC CE may include information indicating an activated or a non-activated CSI AperiodicTriggerState. That is, the MAC CE may point to an aperiodic CSI-RS resource set of an activated CSI-AperiodicTriggerState, or may point to an aperiodic CSI-RS resource set of a non-activated CSI-AperiodicTriggerState. In a case that the CSI-AperiodicTriggerState pointed to by the MAC CE is in non-activated state, the network side activates the CSI-AperiodicTriggerState and assumes that the UE has activated the CSI-AperiodicTriggerState as well. Then, the network side triggers the aperiodic CSI-RS beam sweeping via DCI. In a case that the CSI-AperiodicTriggerState pointed to by the MAC CE is in activated state, the network side triggers the aperiodic CSI-RS beam sweeping via DCI.

In a case that a parameter Repetition of the CSI-RS resource set is ON, it indicates that CSI-RS resources are to be transmitted repeatedly in space, with a purpose of enabling the UE to locate an appropriate receiving beam, that is, the UE performs receiving beam sweeping. In this case, the UE may not report its located appropriate beam to the network side.

By contrast, in a case that the parameter Repetition in the CSI-RS resource set is OFF, it indicates that the CSI-RS resources in the resource set use different emission beams, with a purpose of locating an appropriate downlink emission beam. In this case, the UE needs to report a located appropriate beam to the network side.

For ease of understanding, FIG. 2 illustrates a schematic diagram of an example of a process of downlink beam sweeping initiated by UE. First, the UE detects an occurrence of a physical layer BM event, and then requests a network side to trigger aperiodic CSI-RS beam sweeping via UCI or MAC CE. The UCI or MAC CE includes information of a CSI-AperiodicTriggerState suggested by the UE. Then, the network side dynamically triggers aperiodic CSI-RS beam sweeping via DCI. The aperiodic CSI-RS beam sweeping is based on the aperiodic CSI-RS resource set pointed to by the CSI-AperiodicTriggerState as mentioned above. In FIG. 2, two dashed line blocks represent two cases that the parameter Repetition of the CSI-RS resource set is ON or OFF respectively. If necessary, for example, when the Repetition is OFF, the UE reports information of a located appropriate beam to the network side.

On the other hand, the execution unit 102 may request the network side to trigger uplink beam sweeping initiated by the UE via UCI or MAC CE. For example, in a case that the UE found that the emission beam for a sounding reference signal (SRS) of the UE may no longer be applicable, the UE may initiate an uplink beam sweeping process based on the SRS. Specifically, the UCI or MAC CE may include a parameter aperiodicSRS-ResourceTrigger as information for triggering the uplink beam sweeping.

Due to the fact that a sweeping beam of SRS is transmitted by the UE, and generally the UE cannot decide on its own whether to occupy an uplink resource to transmit the SRS, this process requires confirming by the network side. That is, the network side indicates whether to permit the UE to transmit the aperiodic SRS. Correspondingly, the execution unit 102 is further configured to obtain, from the network side, confirmation for uplink beam sweeping.

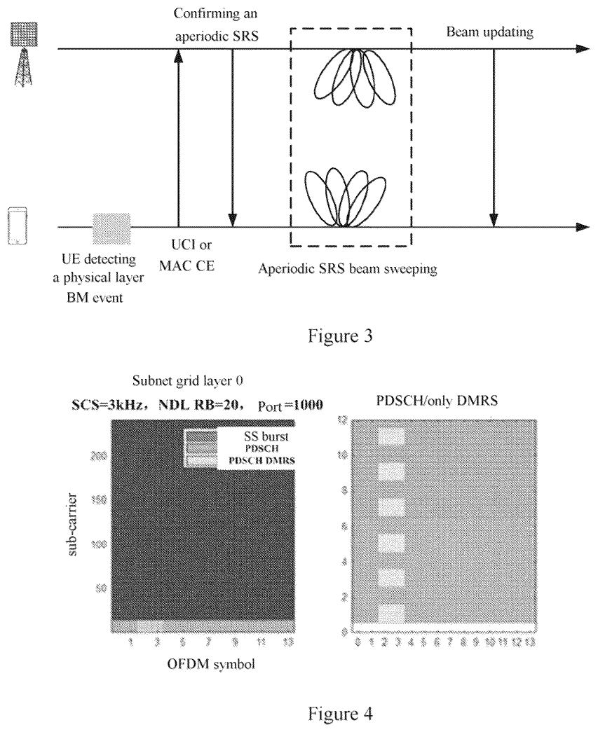

FIG. 3 illustrates a schematic diagram of an example of a process of uplink beam sweeping initiated by the UE. First, the UE detects an occurrence of a physical layer BM event, and then requests the network side to trigger aperiodic SRS beam sweeping via UCI or MAC CE. The UCI or MAC CE includes information of aperiodicSRS-ResourceTrigger suggested by the UE. Then, the network side dynamically confirms the aperiodic SRS beam sweeping suggested by the UE via DCI, and the UE performs the aperiodic SRS beam sweeping upon reception of the confirmation. Then, the network side updates the uplink beam based on a scanning result.

It should be understood that the process and signaling of the beam sweeping initiated by the UE described above are only illustrative and non-restrictive, and can be adaptively modified based on a specific demand in a practical application.

### Beam Reporting Initiated by the UE

In this case, the execution unit 102 may be configured to measure a reference signal received by the UE and perform beam reporting initiated by the UE based on a measurement result.

The reference signal may include any one or more of the following: a synchronization signal block (SSB), a channel state information reference signal (CSI-RS), and a demodulation reference signal (DMRS).

The SSB and CSI-RS may be considered to be based on active beam sweeping. This is because in an NR system, the active beam sweeping and reporting procedure triggered by a base station usually occurs before a PDSCH transmission to the UE, that is, the beam sweeping procedure serves the subsequent transmission of a control channel and a data channel (which may be referred to as measurement and reporting of prior PDSCH).

The DMRS may be considered to be based on passive beam sounding. This is because as the UE completes sounding of a downlink control channel and a downlink data channel, the UE also completes measurement of the DMRS for the channel. Therefore, the reporting may be performed based on a measurement result of the DMRS in a case of performing the beam reporting initiated by the UE. It should be understood that the reporting of the measurement result based on the DMRS may be applied to the reporting initiated by the UE according to the present disclosure, and may also be applied to the reporting initiated by a network side.

For a control channel, the UE may measure the DMRS in one or two beam directions for each control resource set (CORESET). For a data channel, the UE may measure the DMRS for up to beam directions indicated by 8 transmission configuration indicator (TCI) states. Apparently, each PDSCH transmission generally corresponds to one or two TCI states, as shown in FIG. 4 and FIG. 5. It should be noted that two TCI states are utilized only when two TRPs perform transmission to the UE; and only one TCI state is utilized when a single TRP performs transmission to the UE.

The UE may measure a physical layer reference signal reception power (L1-RSRP) or physical layer signal-to-interference-and-noise ratio (L1-SINR) of the DMRS. For example, the L1-RSRP of DMRS is defined as a linear average of a power contribution (in watts) of resource units carrying antenna ports of DMRS configured for a PDSCH or PDCCH within a frequency bandwidth considered in a case of the PDSCH or PDCCH. The L1-SINR of DMRS is defined equal to a linear average of a power contribution (in Watts) of resource units carrying the DMRS divided by a linear average of noise and interference power contributions (in Watts). In a case that the L1-SINR of DMRS is used for L1-SINR reporting with dedicated interference measurement resources, interference and noise can be measured on resources indicated by a higher layer. Otherwise, interference and noise may be measured on resource units carrying DMRS within a same frequency bandwidth.

In addition, after measuring the RSRP of the beam corresponding to the reference signal, the UE may obtain an attenuation of a beam power by calculating a difference between the transmission power and the RSRP of the beam, so as to determine the channel quality. For example, smaller attenuation of the beam power leads to better quality of a corresponding beam in the channel. Therefore, in order to fairly compare beam performances of beams, the UE needs to know the transmission power of each beam.

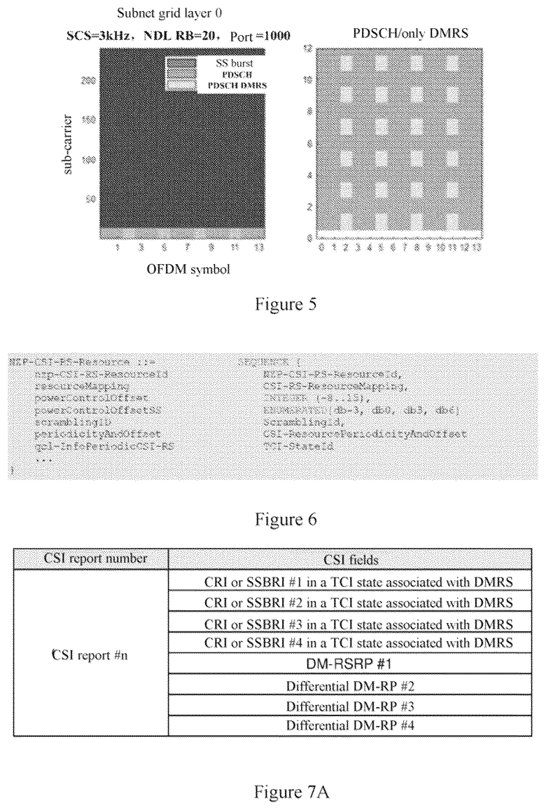

For example, the transmission power of the SSB is configured to the UE by the network side via radio resource control (RRC) signaling, a power of the CSI-RS is notified to the UE by the network side through a power ratio of CSI-RS/SSB, and a power of the DMRS is notified to the UE by the network side through a power ratio of DMRS/CSI-RS. Corresponding signaling is shown in FIG. 6.

In FIG. 6, PowerControlOffset represents a power offset, in dB, of a PDSCH resource unit relative to an NZP CSI-RS resource unit, that is, a power ratio of DMRS/CSI-RS. In addition, the PowerControlOffsetSS represents a power offset, in dB, of an NZP CSI-RS resource unit relative to a Secondary Synchronization Signal (SSS) resource unit, that is, a power ratio of CSI-RS/SSB.

Based on this, after the UE performs the measurement of a beam corresponding to the DMRS, a result of the measurement may be compared with a beam measurement result based on the CSI-RS and SSB. For example, the UE may measure and compare a DM-RSRP of a downlink beam A, an SS-RSRP of a downlink beam B, and a CSI-RSRP of a downlink beam C.

In a case that a reference signal measured by the UE includes a DMRS, the execution unit 102 is configured to report one of the following: a TCI state identification (ID) corresponding to the DMRS; and an ID of an SSB or CSI-RS included in a TCI state corresponding to the DMRS.

Since the DMRS itself does not have a resource ID, the UE may rely on information related to the TCI state corresponding to the DMRS.

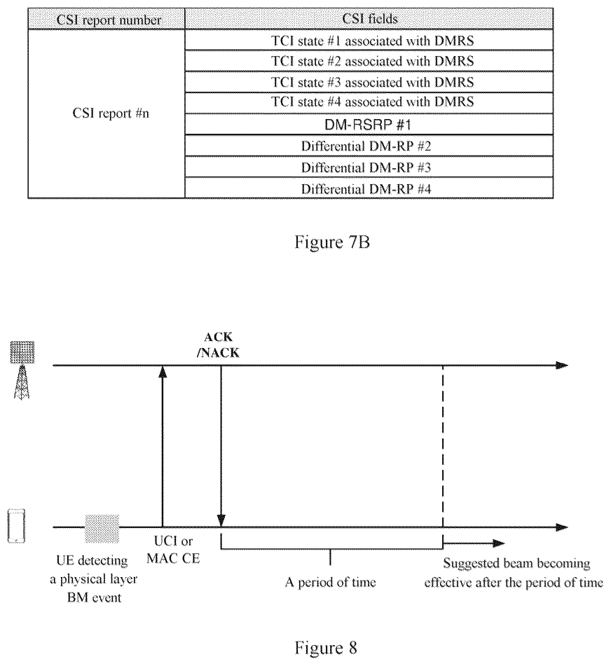

FIG. 7A shows an example of reporting an ID of an SSB or CSI-RS included in a TCI state corresponding to a DMRS. In FIG. 7A, the first column indicates a number of a Channel State Information (CSI) report, and the second column indicates a CSI field. Each CSI report may include one or more entries, up to a maximum of four, as shown in FIG. 7A. In the example in FIG. 7A, a CSI-RS Resource Indicator (CRI) or SSB Resource Indicator (SSBRI) in the TCI state associated with a DMRS, and a corresponding RSRP of the DMRS are reported. In FIG. 7A, an RSRP of a first DMRS is an absolute value of a measured RSRP, DM-RSRP #1, and an RSRP of another DMRS is a differential value relative to the DM-RSRP #1.

FIG. 7B shows an example of reporting a TCI state ID corresponding to a DMRS. Similar to FIG. 7A, the first column indicates a number of a CSI report, and the second column indicates a CSI field. Each CSI report may include one or more entries, up to a maximum of four, as shown in FIG. 7B. In the example in FIG. 7B, a TCI state ID associated with a DMRS and a corresponding RSRP of a DMRS are reported. In FIG. 7B, an RSRP of a first DMRS is an absolute value of a measured RSRP, DM-RSRP #1, and an RSRP of another DMRS is a differential value relative to the DM-RSRP #1. In this way, a TCI state which is more appropriate for the UE can be indicated more clearly. In a case that a reported content from the UE can serve as a beam automatically activated or selected by the UE, a TCI state is a more direct option.

The above example shows a situation where four beams are reported by the UE. The network side may select one or two of the four beams to use, which is not limited here. UE may report only one beam (corresponding to a single TRP, for example) or two beams (corresponding to multiple TRPs, for example). In this case, the network side does not need to select, but may use the reported beam directly.

### Beam Activation or Beam Selecting Initiated by the UE

Beam activation and beam selecting initiated by the UE are described together, due to the similar characteristics thereof. For example, for a control channel or signal having a relatively static beam change, an NR system usually uses the concept of beam activation. For a data channel having a relatively dynamic beam change, the NR system usually uses the concept of beam selecting, which involves selecting a most appropriate beam from among multiple activated beams to use.

Furthermore, although the beam activation or beam selecting initiated by the UE is described separately here, the beam reporting and the beam activation or selecting initiated by the UE may be a same procedure, that is, the UE activates a certain reported beam or informs a NW of its selection during the reporting process. That is, the two may be a common signaling procedure or signaling procedures independent from each other, which is not limited here.

The execution unit 102 is configured to transmit information of a beam suggested by the UE to the network side in the beam activation initiated by the UE or beam selecting initiated by the UE. That is, the UE may suggest to the network side which uplink or downlink beam should be activated or selected. For example, the execution unit 102 may perform transmission via UCI or MAC CE.

In addition, the execution unit 102 may obtain, from the network side, information indicating a range of beams from which the UE suggests a beam. That is, the network side sets a range in advance, and the execution unit 102 suggests, within the range, a beam which can be activated or selected.

Hereinafter provided is an example of activation and selecting of a downlink beam. For example, the network side pre-configures four beams, i.e., beam #1, beam #3, beam #5, and beam #8, and the UE can only activate or select one or more beams from the four beams. By limiting the beam selected or activated by the UE on its own to a range configured or specified by the network side, a range of beams reported by the UE can be narrowed, and thereby an uplink signaling overhead of the UE is reduced.

In addition, the execution unit 102 may receive information of adjustment on the range by the network side via MAC CE. That is, in a case that the beam range configured by the network side changes, the network side may adjust the range via MAC CE. For example, the MAC CE transmitted by the network side to the UE includes: beam #2, beam #4, beam #5, and beam #9. In this way, a pre-configured set of beams can be covered and the range for autonomous beam activation and selection by the UE is dynamically adjusted.

For example, the transmitted information of the beam suggested by the UE may include a unified TCI state that can be used for both an uplink beam and a downlink beam. Here, the Rel.17 unified TCI state activated or selected by the UE is different from the traditional TCI state defined in Rel.15/16. First, the unified TCI state can serve not only downlink transmission but also uplink transmission, and even the unified TCI state can serve both uplink transmission and downlink transmission simultaneously. From a functional perspective, the Rel.15/16 TCI state and the Rel.17 unified TCI state provide different functions for an NR system.

Alternatively, information of the uplink beam includes a TCI state, and information of the downlink beam includes spatial relationship information (SRI).

Examples of the beam activation or selecting initiated by the UE are described below with respect to a downlink channel and signal and an uplink channel and signal.

The following description is about the downlink channel and signal. For example, for a PDCCH, the UE may activate one TCI state (for a single TRP) or two TCI states (for multiple TRPs) for each CORESET, as a change frequency of a beam for the PDCCH is slower than that of a beam for a PDSCH, the beam activation initiated by the UE may be utilized only. For the PDSCH of each BWP, the UE may autonomously activate eight or more (16, for example) TCI states. In a case that the UE is confident about an appropriate beam, the UE may select one TCI state (for a single TRP) or two TCI states (for multiple TRPs), that is, beam activation or beam selecting initiated by the UE may be utilized. For periodic, semi static, or aperiodic CSI-RS resources, the UE may activate or select an appropriate TCI state for each CSI-RS resource.

The following description is about the uplink channel and signal. For example, for a PUCCH resource, the UE may activate one TCI state (for a single TRP) or two TCI states (for multiple TRPs), or activate one SRI (for a single TRP) or two SRIs (for multiple TRPs). For the PUSCH of each BWP, the UE may activate eight or more (16, for example) TCI states. In a case that the UE is confident about an appropriate beam, the UE may select one TCI state (for a single TRP) or two TCI states (for multiple TRPs), that is, beam activation or beam selecting initiated by the UE may be utilized. For uplink periodic, semi static, or aperiodic SRS resources, the UE may activate or select an appropriate TCI state or SRI for each SRS resource.

In addition, in a case that the UE is configured with multiple component carriers, i.e., in a case that carrier aggregation is applied, some component carriers (CC) may communicate using the same beam pair. That is, when a beam is activated or selected by the UE (such as a certain TCI state), the CSI-RS or SSB included in the TCI state is applicable not only to a CC of a current serving cell, but also to a CC of other cells. Therefore, the beam activation or beam selecting initiated by the UE across CCs may be performed.

Specifically, the execution unit 102 may be further configured to receive a list of component carriers from the network side, where the beam suggested by the UE is applicable to each of the component carriers in the list. That is, multiple CCs to which the suggested beam is applicable are pre-configured by the network side through a CC list.

The network side may or may not provide feedback for the beam activation or beam selecting initiated by the UE. Three schematic examples of relevant signaling are described below with reference to FIG. 8 to FIG. 10. As mentioned above, the execution unit 102 may transmit information of the beam suggested by the UE via UCI or MAC CE.

As shown in FIG. 8, the UE receives an ACK or NACK message from the network side for the transmission. That is, the network side transmits, via DCI, an implicit ACK or NACK with respect to a PUSCH carrying the UCI or MAC CE. In this example, on reception of the ACK message from the network side, the execution unit 102 determines that the beam suggested by the UE is correctly received and approved by the network side. That is, the ACK indicates that the network side has correctly received the PUSCH and approved (or confirmed) content (that is, information of the beam activation or selection) of the UCI or MAC CE carried by the PUSCH. In this case, the suggested beam becomes effective after a period of time (measured in unit of symbols or ms). Otherwise, in a case that an NACK message is received from the network side by the execution unit 102, it means that the network side fails to receive a PUSCH correctly or does not approve the beam suggested by the UE. In this case, the suggested beam cannot become effective.

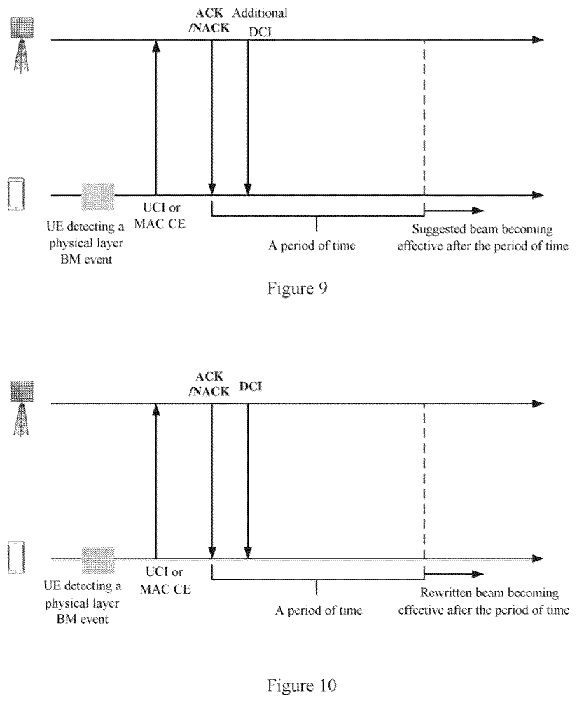

As another example, as shown in FIG. 9, in a case that the PUSCH is correctly received on the network side, an implicit ACK is transmitted via DCI, and the network side transmits additional DCI to indicate that the beam activated or selected by the UE included in the UCI or MAC CE is acknowledged by the network side. In a case that the UE fails to receive the additionally transmitted DCI within a predetermined time window (i.e., the period of time marked in the figure), it is considered that the beam activated or selected by the UE is not approved by the network side, that is, the beam activated or selected autonomously by the UE is invalid and the old beam is still to be used. On the contrary, in a case that the UE receives the additionally transmitted TCI within the predetermined time window, it is considered that the beam activated or selected by the UE is approved by the network side. Hence, the suggested beam becomes effective after the predetermined time window elapses. In this example, the execution unit 102 is configured to determine that the beam suggested by the UE is correctly received and approved by the network side, in a case of receiving an ACK message from the network side and receiving additional DCI indicating approval within a predetermined time window.

In another example, as shown in FIG. 10, in a case that the network side receives a PUSCH correctly, an implicit ACK is transmitted via DCI. In a case that the beam suggested by the UE is approved by the network side, the network side then remains silent for a predetermined time window, and the beam suggested by the UE becomes effective after a period of time. In a case that the beam suggested by the UE is not approved by the network side, the beam suggested by the UE is rewritten by additional DCI (as shown in FIG. 10). The beam after rewriting by the network side becomes effective after a period of time. In this example, the execution unit 102 determines that the beam suggested by the UE is correctly received and approved by the network side, in a case of receiving an ACK message from the network side and no receiving additional DCI within a predetermined time window. In this way, a signaling overhead can be reduced, while ensuring consistency between the network side and the UE in understanding of an activated or selected beam at the same time.

In addition, the execution unit 102 may also be further configured to receive, from the network side, an indication of whether to enable a beam management function initiated by the UE. For example, the execution unit 102 may receive the indication via RRC signaling. The execution unit 102 may further receive, from the network side, an indication about which beam management function initiated by the UE is to be enabled and/or a related parameter. For example, the execution unit 102 may receive one or more of the following from the network side: an indication for enabling beam activation or beam selecting initiated by the UE, an indication of a channel or signal for which the beam activation or beam selecting initiated by the UE is enabled, an indication about how many uplink or downlink beams are available to be activated or selected by the UE, and the like. It should be noted that what described above is only an example, and the network side may configure the beam management function initiated by the UE as needed.

In summary, with the electronic apparatus 100 according to the embodiment of the present disclosure, the beam management can be performed in response to occurrence of the physical layer beam event through the beam management procedure initiated by the UE. Thereby, a latency caused by the beam management procedure is reduced and communication quality is improved.

### Second Embodiment

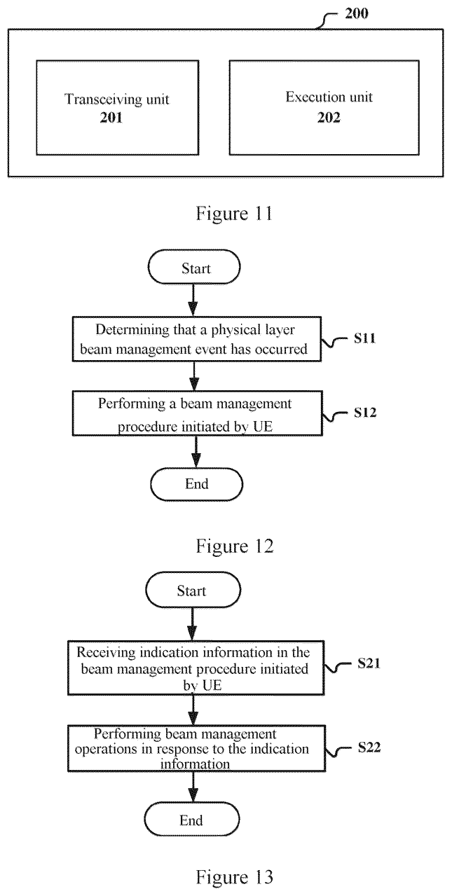

FIG. 11 illustrates a block diagram of functional modules of an electronic apparatus 200 for wireless communications according to an embodiment of the present disclosure. As shown in FIG. 11, the electronic apparatus 200 includes: a transceiving unit 201 configured to receive indication information in a beam management procedure initiated by the user equipment; and an execution unit 202 configured to perform beam management operations in response to the indication information.

The transceiving unit 201 and the execution unit 202 may be implemented by one or more processing circuits. The processing circuitry may be implemented as a chip or a processor, for example. It should be understood that various functional units in the electronic apparatus shown in FIG. 11 are only logical modules determined based on specific functions thereof, and are not for limiting a specific implementation.

The electronic apparatus 200 may, for example, be provided on a network side or be communicatively connected to the network side. The network side described in the specification may be a base station, such as a gNB, an eNB, a TRP, and an Access Point (AP). Here, it should be noted that the electronic apparatus 200 may be implemented at a chip level or at a device level. For example, the electronic apparatus 200 may operate as the network side itself and may further include a memory, a transceiver (not shown), and other external devices. The memory may store programs that the network side needs to execute to achieve various functions and related data information. The transceiver may include one or more communication interfaces to support communications with different devices (such as UE, another base station, and the like). An implementation of the transceiver is not specifically limited here.

According to an embodiment, the electronic apparatus supports the beam management initiated by the UE by receiving indication information related to the beam management from the UE. The same or corresponding content as in the first embodiment is not repeated hereinafter, and may be referred to in the first embodiment.

In an example, the indication information includes beam sweeping trigger information. The transceiving unit 201 may receive the beam sweeping trigger information from the UE via UCI or MAC CE. For example, on detection of a physical layer BM event, the UE determines that aperiodic beam sweeping is necessary and transmits the beam sweeping trigger information to the network side.

The beam sweeping trigger information may include information for triggering downlink beam sweeping. In a case that the information is received via UCI, the information includes information indicating an activated CSI-AperiodicTriggerState. In a case that the information is received via MAC CE, the information includes information indicating an activated or a non-activated CSI-AperiodicTriggerState. The CSI-AperiodicTriggerState directs to an aperiodic CSI-RS resource set.

Correspondingly, on reception of downlink beam sweeping information indicating an activated CSI-AperiodicTriggerState, the execution unit 202 triggers aperiodic CSI-RS beam sweeping based on the CSI-AperiodicTriggerState, as shown in FIG. 2. The execution unit 202 may perform dynamic trigger via DCI. On reception of downlink beam sweeping information indicating a non-activated CSI-AperiodicTriggerState, the execution unit 202 activates a corresponding CSI-AperiodicTriggerState and triggers aperiodic CSI-RS beam sweeping. In this case, the execution unit 202 considers that the CSI-AperiodicTriggerState is also activated by the UE. Similarly, the execution unit 202 may perform dynamic trigger via DCI.

Reference is made back to FIG. 2. In a case that the CSI-AperiodicTriggerState directs to a CSI-RS resource set whose parameter Repetition is ON, the CSI-RS is transmitted repeatedly in space to enable the UE to locate an appropriate receiving beam, that is, the UE performs receiving beam sweeping. In this case, the UE may not report its located appropriate beam to the network side. By contrast, in a case that the parameter Repetition in the CSI-RS resource set is OFF, it indicates that the CSI-RS resources in the resource set use different emission beams, with a purpose of locating an appropriate downlink emission beam. In this case, the UE needs to report a located appropriate beam to the network side, where the transceiving unit 201 performs a corresponding reception.

In addition, the beam sweeping trigger information may include information for triggering uplink beam sweeping. The information may include aperiodicSRS-ResourceTrigger. The execution unit 202 transmits an acknowledgement message to the UE in response to the information, to allow the UE to transmit an aperiodic SRS, as shown in FIG. 3. After SRS beam sweeping is completed, the execution unit 202 updates the uplink beam.

In another example, the indication information may include a reference signal measurement result reported by the UE. As mentioned in the first embodiment, in a case that the UE performs passive beam sounding based on a DMRS, the reference signal measurement result may include one of the following: a TCI state ID corresponding to the DMRS; and an ID of an SSB or CSI-RS included in a TCI state corresponding to the DMRS. Since the DMRS itself does not have a resource ID, the UE may use the TCI state ID or ID of the SSB or CSI-RS for reporting. In addition, the indication information may further include an RSRP of a corresponding DMRS. Specific examples may be referred to FIG. 7A and FIG. 7B, and are not repeated here.

In another example, the indication information may include information of a beam suggested by the UE for beam activation or beam selecting. As mentioned above, for a control channel or signal having a relatively static beam change, an NR system usually uses the concept of beam activation. For a data channel having a relatively dynamic beam change, the NR system usually uses the concept of beam selecting, which involves selecting a most appropriate beam from among multiple activated beams to use.

UE suggests to the network side which uplink or downlink beam should be activated or selected based on measurement, for example, and includes information of the beam into the indication information to be provided to the network side. For example, the transceiving unit 201 may receive information of the suggested beam from the UE via UCI or MAC CE.

In addition, the transceiving unit 201 may further transmit, to the UE, information indicating a range of beams from which the UE suggests a beam. That is, the network side sets a range in advance, and the UE suggests, from the range, a beam which can be activated or selected. By limiting the beam selected or activated by the UE automatously to a range configured or specified by the network side, a range of beams reported by the UE can be narrowed, and thereby an uplink signaling overhead of the UE is reduced. In addition, the transceiving unit 201 may transmit, to the UE, information of adjustment on the range via MAC CE, to dynamically adjust the range from which the UE performs autonomous beam activation and beam selecting.

For example, the information of the beam suggested by the UE may include a unified TCI state that can be used for both an uplink beam and a downlink beam. Alternatively, information of an uplink beam includes a TCI state, and information of a downlink beam includes an SRI.

On reception of the information of the beam suggested by the UE, the transceiving unit 201 transmits an ACK or NACK message for the reception.

In the example shown in FIG. 8, the transceiving unit 201 transmits an ACK message to the UE in a case that the beam suggested by the UE is correctly received and approved by the network side. That is, the ACK indicates that the network side has correctly received a PUSCH and approved (or acknowledged) content (that is, information of beam activation or selection) of the UCI or MAC CE carried by the PUSCH. In this case, the beam suggested by the UE becomes effective after a period of time (measured in symbols or ms). Otherwise, a NACK message indicates that the network side fails to receive a PUSCH correctly or does not approve the beam suggested by the UE. In this case, the beam suggested by the UE cannot become effective.

In the example shown in FIG. 9, the transceiving unit 201 transmits an ACK message to the UE and transmits additional DCI indicating approval within a predetermined time window, in a case that the beam suggested by the UE is correctly received and approved by the network side. That is, the ACK message indicates that a PUSCH is received by the network side correctly, and the additionally transmitted DCI indicates that the beam suggested by the UE is approved by the network side. In a case that the beam suggested by the UE is not approved by the network side, no additional DCI is transmitted. Hence, the UE fails to receive the additionally transmitted DCI within a predetermined time window, and determines that the beam activated or selected by the UE is not approved by the network side, that is, the beam activated or selected autonomously by the UE is invalid and the old beam is still to be used. On the contrary, in a case that the beam suggested by the UE is approved by the network side, additional DCI is transmitted additionally within the predetermined time window. Hence, the UE receives the additional DCI and determines that the beam activated or selected by the UE is approved by the network side. Thereby, the suggested beam becomes effective after the predetermined time window elapses.

In the example shown in FIG. 10, the transceiving unit 201 transmits an ACK message to the UE and transmits additional DCI including information of a beam rewritten by the network side within a predetermined time window, in a case that the beam suggested by the UE is correctly received but not approved by the network side. That is, the network side does not acknowledge the suggested beam under a normal circumstance. The network side remain silent for a predetermined time window in a case of approving the beam suggested by the UE. Then, the beam suggested by the UE becomes effective after a period of time. In a case that the network side does not approve the beam suggested by the UE, the network side rewrites the beam suggested by the UE via additional DCI (as in the case shown in FIG. 10). The beam rewritten by the network side becomes effective after a period of time.

In addition, in a case that the UE is configured with multiple component carriers, i.e., in a case that carrier aggregation is applied, some component carriers (CCs) may communicate using the same beam pair. That is, when a beam is activated or selected by the UE (such as a certain TCI state), the CSI-RS or SSB included in the TCI state is applicable not only to a CC of a current serving cell, but also to a CC of other cells. Therefore, the beam activation or beam selecting initiated by the UE may be performed across CCs.

Specifically, the transceiving unit 201 may be further configured to transmit a list of component carriers to the UE, where the beam suggested by the UE is applicable to each of the component carriers in the list. That is, multiple CCs to which the suggested beam is applicable are pre-configured for the UE by the network side.

In addition, the transceiving unit 201 may be further configured to transmit, to the UE, an indication of whether to enable a beam management function initiated by the UE. For example, the transceiving unit 201 may transmit the indication via RRC signaling. The transceiving unit 201 may further transmit, to the UE, an indication about which beam management function initiated by the UE is to be enabled and/or a related parameter. For example, the transceiving unit 201 may transmit one or more of the following to the UE: an indication for enabling beam activation or beam selecting initiated by the UE, an indication of a channel or a signal for which the beam activation or beam selecting initiated by the UE is enabled, an indication about how many uplink or downlink beams are available to be activated or selected by the UE, and the like. It should be noted that what described above is only an example, and the network side may configure the beam management function initiated by the UE as needed.

In summary, with the electronic apparatus 200 according to the embodiment of the present disclosure, the beam management procedure initiated by the UE is supported, so that the UE is enabled to perform the beam management in response to occurrence of the physical layer beam event. Thereby, a latency caused by the beam management procedure is reduced and the communication quality is improved.

### Third Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

FIG. 12 shows a flowchart of a method for wireless communications according to an embodiment of the present disclosure. The method includes: determining that a physical layer beam management event has occurred (S11); and performing a beam management procedure initiated by UE (S12). The method is performed on a UE side, for example.

For example, the beam management procedure initiated by the UE may include any one or more of the following: beam sweeping initiated by the UE, beam reporting initiated by the UE, beam activation initiated by the UE, and beam selecting initiated by the UE.

In an example, in step S12, a network side is requested, via UCI or MAC CE, to trigger the beam sweeping initiated by the UE. The UCI or MAC CE may include information for triggering downlink beam sweeping. The UCI may include information indicating an activated CSI-AperiodicTriggerState. The MAC CE may include information indicating an activated or a non-activated CSI-AperiodicTriggerState.

In addition, the UCI or MAC CE may include information for triggering uplink beam sweeping. For example, the UCI or MAC CE may include an aperiodicSRS-ResourceTrigger as information for triggering the uplink beam sweeping. In this case, the above method further includes: obtaining, from the network side, confirmation of the uplink beam sweeping by the network side (not shown in the figure).

In another example, a reference signal received by the UE is measured in step S11, and beam reporting initiated by the UE is performed in step S12 based on a measurement result. The reference signal may include any one or more of the following: an SSB, a CSI-RS, and a DMRS.

In a case that the reference signal includes a DMRS, one of the following may be reported in step S12: a TCI state ID corresponding to the DMRS; and an ID of an SSB or CSI-RS included in a TCI state corresponding to the DMRS.

In another example, in step S12, information of a beam suggested by the UE is transmitted to the network side in the beam activation initiated by the UE or beam selecting initiated by the UE. The information of the beam may include a unified TCI state that can be used for both an uplink beam and a downlink beam. Alternatively, information of the uplink beam includes a TCI state, and information of the downlink beam includes an SRI. In addition, the method may further include obtaining, from the network side, information indicating a range of beams from which the UE suggests a beam, and the method may further include receiving, via MAC CE, information of adjustment on the range by the network side.

In step S12, the transmission may be performed via UCI or MAC CE, and an ACK or NACK message for the transmission may be received from the network side. For example, on reception of the ACK message from the network side, it is determined that the beam suggested by the UE is correctly received and approved by the network side. Alternatively, on reception of an ACK message from the network side and reception of additional DCI indicating approval within a predetermined time window, it is determined that the beam suggested by the UE is correctly received and approved by the network side. Alternatively, on reception of an ACK message from the network side and no reception of additional DCI within a predetermined time window, it is determined that the beam suggested by the UE is correctly received and approved by the network side.

The method may further include a step of receiving a list of component carriers from the network side, where the beam suggested by the UE is applicable to each of the component carriers in the list.

In addition, the method may further include: receiving, from the network side, an indication of whether to enable a beam management function initiated by the UE. For example, the indication may be received via RRC signaling.

FIG. 13 shows a flowchart of a method for wireless communications according to another embodiment of the present disclosure. The method includes: receiving indication information in a beam management procedure initiated by user equipment (S21); and performing beam management operations in response to the indication information (S22). The method may be performed on a network side, for example.

In an example, the indication information includes beam sweeping trigger information. The beam sweeping trigger information may be received from the UE via UCI or MAC CE in step S21. For example, the beam sweeping trigger information may include information for triggering downlink beam sweeping. In a case that the information is received via UCI, the information includes information indicating an activated CSI-AperiodicTriggerState. In a case that the information is transmitted via MAC CE, the information includes information indicating an activated or a non-activated CSI-AperiodicTriggerState. In step S22, beam sweeping of an aperiodic CSI-RS is triggered based on the information of an activated CSI-AperiodicTriggerState, or the corresponding CSI-AperiodicTriggerState is activated based on the information of a non-activated CSI-AperiodicTriggerState and the beam sweeping of an aperiodic CSI-RS is triggered. In addition, the beam sweeping trigger information may include information for triggering uplink beam sweeping. The information includes aperiodicSRS-ResourceTrigger. An acknowledgement message is transmitted to the UE in step S22 in response to the information, to allow the UE to transmit an aperiodic SRS.

In another example, the indication information includes a reference signal measurement result reported by the UE. The reference signal may include a DMRS, the reference signal measurement result includes one of the following: a TCI state ID corresponding to the DMRS; and an ID of an SSB or CSI-RS included in a TCI state corresponding to the DMRS.

In another example, the indication information includes information of a beam suggested by the UE for beam activation or beam selecting. For example, the information of the beam may include a unified TCI state that can be used for both an uplink beam and a downlink beam. Alternatively, information of the uplink beam includes a TCI state, and information of the downlink beam includes an SRI.

In step S21, the information of the beam may be received from the UE via UCI or MAC CE. In step S22, an ACK or NACK message may be transmitted with respect to reception of the information of the beam.

As a way, the ACK message is transmitted to the UE in step S22 in a case that the beam suggested by the UE is correctly received and approved by the network side. As another way, in a case that the beam suggested by the UE is correctly received and approved by a network side, the ACK message is transmitted to the UE and additional DCI indicating approval is transmitted within a predetermined time window in step S22. As yet another way, in a case that the beam suggested by the UE is correctly received but not approved by a network side, the ACK message is transmitted to the UE and additional DCI including information of a beam rewritten by the network side is transmitted within a predetermined time window in step S22.

In this example, the method may further include transmitting, to the UE, information indicating a range of beams from which the UE suggests a beam, and may further include transmitting, to the UE, information of adjustment on the range via MAC CE. In this example, the method further includes: transmitting a list of component carriers to the UE, where the beam suggested by the UE is applicable to each of the component carriers in the list.

In addition, the method further includes: transmitting, to the UE, an indication of whether to enable a beam management function initiated by the UE. For example, the indication may be transmitted via RRC signaling.

It should be noted that the above-mentioned methods may be performed in combination or independently. Details of the methods are described in detail in the first embodiment and the second embodiment, and are not repeated here.

The technology of the present disclosure can be applied to various products.

For example, the electronic apparatus 100 may be implemented as various user equipment. The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). Furthermore, the user equipment may be a wireless communication module (such as an integrated circuit module including a single wafer) installed on each of the above-mentioned terminals.

The electronic apparatus 200 may be implemented as various base stations. The base station may be implemented as any type of evolved Node B (eNB) or gNB (5G base station). An eNB includes, for example, a macro eNB and a small eNB. A small eNB may be an eNB that covers a cell smaller than a macro cell, such as a pico eNB, a micro eNB, and a home (femto) eNB. A similar situation may apply to the gNB. Alternatively, the base station may be implemented in any other type, such as a NodeB and a base transceiver station (BTS). The base station may include: a main body (also referred to as base station equipment) configured to control wireless communications; and one or more remote radio heads (RRHs) arranged at a different place from the main body. In addition, the UE may serve as a base station by temporarily or semi-permanently performing functions of the base station.

### Application Examples of Based Station

### First Application Example

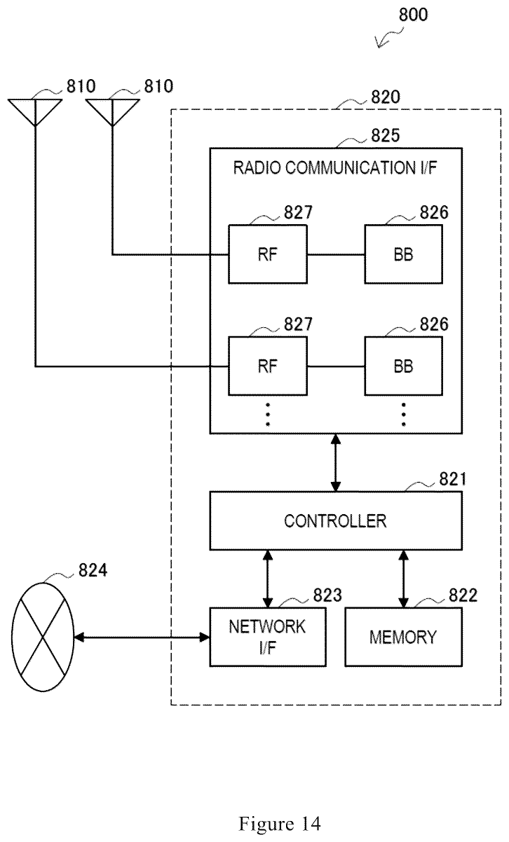

FIG. 14 is a block diagram illustrating a first example of an exemplary configuration of an eNB or gNB to which the technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via a radio frequency (RF) cable.

Each of the antennas 810 includes a single or multiple antennal elements (such as multiple antenna elements included in a multiple-input multiple-output (MIMO) antenna), and is used for the base station apparatus 820 to transmit and receive wireless signals. As illustrated in FIG. 14, the eNB 800 may include the multiple antennas 810. For example, the multiple antennas 810 may be compatible with multiple frequency bands used by the eNB 800. Although FIG. 14 illustrates the example in which the eNB 800 includes the multiple antennas 810, the eNB 800 may include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as a terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an SI interface and an X2 interface). The network interface 823 may also be a wired communication interface or a wireless communication interface for wireless backhaul. In a case that the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and perform various types of signal processing of layers (such as L1, Media Access Control (MAC), Radio Link Control (RLC), and a Packet Data Convergence Protocol (PDCP)). The BB processor 826 may have a part or all of the above-described logical functions, to replace the controller 821. The BB processor 826 may be a memory storing communication control programs, or a module including a processor and a related circuit configured to execute the programs. Updating the program may allow the functions of the BB processor 826 to be changed. The module may be a card or a blade inserted into a slot of the base station apparatus 820. Alternatively, the module may be a chip mounted on the card or the blade. Meanwhile, the RF circuit 827 may include, for example, a mixer, a filter, and an amplifier, and transmits and receives wireless signals via the antenna 810.

As illustrated in FIG. 14, the radio communication interface 825 may include multiple BB processors 826. For example, the multiple BB processors 826 may be compatible with multiple frequency bands used by the eNB 800. The radio communication interface 825 may include multiple RF circuits 827, as illustrated in FIG. 14. For example, the multiple RF circuits 827 may be compatible with multiple antenna elements. Although FIG. 14 illustrates the example in which the radio communication interface 825 includes multiple BB processors 826 and multiple RF circuits 827, the radio communication interface 825 may include a single BB processor 826 and a single RF circuit 827.

In the eNB 800 as shown in FIG. 14, the transceiving unit 201 and the transceiver of the electronic apparatus 200 may be implemented by the radio communication interface 825. At least part of the functions may be implemented by the controller 821. For example, the controller 821 may support the beam management procedure initiated by UE by performing the functions of the transceiving unit 201 and the execution unit 202, so as to enable the UE to perform the beam management in response to the occurrence of the physical layer beam event. Thereby, the latency caused by the beam management procedure is reduced and the communication quality is improved.

### Second Application Example

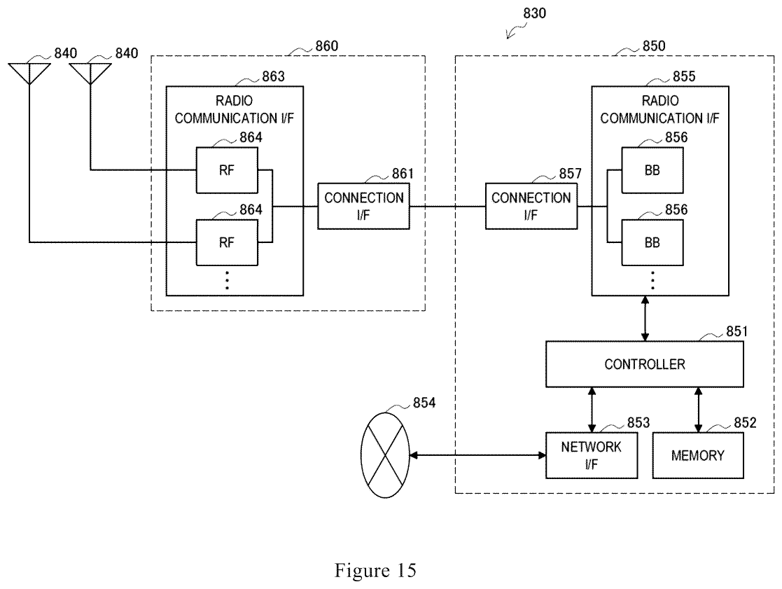

FIG. 15 is a block diagram illustrating a second example of an exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high speed line such as an optical fiber cable.

Each of the antennas 840 includes a single or multiple antennal elements (such as multiple antenna elements included in an MIMO antenna), and is used for the RRH 860 to transmit and receive wireless signals. As illustrated in FIG. 15, the eNB 830 may include multiple antennas 840. For example, the multiple antennas 840 may be compatible with multiple frequency bands used by the eNB 830. Although FIG. 15 illustrates the example in which the eNB 830 includes multiple antennas 840, the eNB 830 may include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 14.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 14, except that the BB processor 856 is connected to an RF circuit 864 of the RRH 860 via the connection interface 857. As illustrated in FIG. 15, the radio communication interface 855 may include multiple BB processors 856. For example, the multiple BB processors 856 may be compatible with multiple frequency bands used by the eNB 830. Although FIG. 15 illustrates the example in which the radio communication interface 855 includes multiple BB processors 856, the radio communication interface 855 may include a single BB processor 856.

The connection interface 857 is an interface for connecting the base station apparatus 850 (radio communication interface 855) to the RRH 860. The connection interface 857 may also be a communication module for communication in the above-described high speed line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high speed line.

The radio communication interface 863 transmits and receives wireless signals via the antenna 840. The radio communication interface 863 may typically include, for example, an RF circuit 864. The RF circuit 864 may include, for example, a mixer, a filter and an amplifier, and transmits and receives wireless signals via the antenna 840. The radio communication interface 863 may include multiple RF circuits 864, as illustrated in FIG. 15.

For example, the multiple RF circuits 864 may support multiple antenna elements. Although FIG. 15 illustrates the example in which the radio communication interface 863 includes multiple RF circuits 864, the radio communication interface 863 may include a single RF circuit 864.

In the eNB 830 as shown in FIG. 15, the transceiving unit 201 and the transceiver of the electronic apparatus 200 may be implemented by the radio communication interface 855 and/or the radio communication interface 863. At least part of the functions may be implemented by the controller 851. For example, the controller 851 may support the beam management procedure initiated by UE by performing the functions of the transceiving unit 201 and the execution unit 202, so as to enable the UE to perform the beam management in response to the occurrence of the physical layer beam event. Thereby, the latency caused by the beam management procedure is reduced and the communication quality is improved.

### Application Examples of User Equipment

### First Application Example

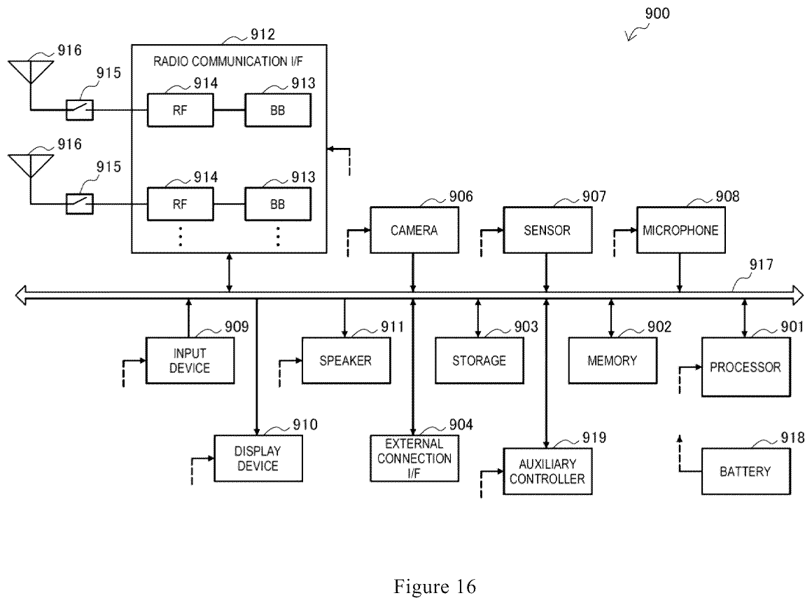

FIG. 16 is a block diagram illustrating an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals outputted from the smartphone 900 to sounds.

The radio communication interface 912 supports any cellular communication scheme (such as LTE and LTE-advanced), and performs wireless communications. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communication. The RF circuit 914 may include, for example, a mixer, a filter and an amplifier, and transmits and receives wireless signals via the antenna 916. It should be noted that although FIG. 16 illustrates a case that one RF link is connected to one antenna, which is only illustrative, and a situation where one RF link is connected to multiple antennas through multiple phase shifters is also possible. The radio communication interface 912 may be a chip module having the BB processor 913 and the RF circuit 914 integrated thereon. The radio communication interface 912 may include multiple BB processors 913 and multiple RF circuits 914, as illustrated in FIG. 16. Although FIG. 16 illustrates the example in which the radio communication interface 912 includes multiple BB processors 913 and multiple RF circuits 914, the radio communication interface 912 may include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a wireless local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include the multiple antennas 916, as illustrated in FIG. 16. Although FIG. 16 illustrates the example in which the smartphone 900 includes multiple antennas 916, the smartphone 900 may include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 16 via feeder lines, which are partially illustrated as dashed lines in FIG. 16. The auxiliary controller 919 operates a minimum necessary function of the smartphone 900, for example, in a sleep mode.

In the smartphone 900 as shown in FIG. 16, the transceiver of the electronic apparatus 100 may be implemented by the radio communication interface 912. At least part of the functions may be implemented by the processor 901 or the auxiliary controller 919. For example, the processor 901 or the auxiliary controller 919 may perform the beam management procedure initiated by UE by performing the functions of the determination unit 101 and the execution unit 102, so as to perform the beam management in response to the occurrence of the physical layer beam event. Thereby, the latency caused by the beam management procedure is reduced and the communication quality is improved.

### Second Application Example

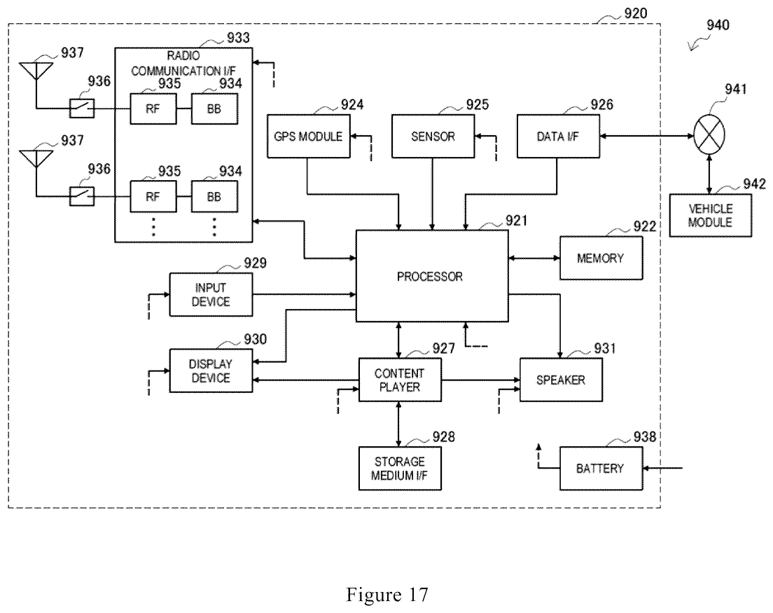

FIG. 17 is a block diagram illustrating an example of a schematic configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes RAM and ROM, and stores a program executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not illustrated, and acquires data (such as vehicle speed data) generated by the vehicle.

The content player 927 reproduces content stored in a storage medium (such as a CD and DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or reproduced content. The speaker 931 outputs a sound for the navigation function or the reproduced content.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communication. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as illustrated in FIG. 17. Although FIG. 17 illustrates the example in which the radio communication interface 933 includes multiple BB processors 934 and multiple RF circuits 935, the radio communication interface 933 may include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used for the radio communication interface 933 to transmit and receive wireless signals. As illustrated in FIG. 17, the car navigation apparatus 920 may include multiple antennas 937. Although FIG. 17 illustrates the example in which the car navigation apparatus 920 includes multiple antennas 937, the car navigation apparatus 920 may include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 illustrated in FIG. 17 via feeder lines that are partially illustrated as dash lines in FIG. 23. The battery 938 accumulates power supplied from the vehicle.

In the car navigation device 920 as shown in FIG. 17, the transceiver of the electronic apparatus 100 may be implemented by the radio communication interface 933. At least part of the functions may be implemented by the processor 921. For example, the processor 921 may perform the beam management procedure initiated by UE by performing the functions of the determination unit 101 and the execution unit 102, so as to perform the beam management in response to the occurrence of the physical layer beam event. Thereby, the latency caused by the beam management procedure is reduced and the communication quality is improved.

The technology according to the present disclosure may also be implemented as an in-vehicle system (or a vehicle) 940 including one or more blocks of the car navigation device 920, the in-vehicle network 941, and a vehicle module 942. The vehicle module 942 generates vehicle data (such as vehicle speed, engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

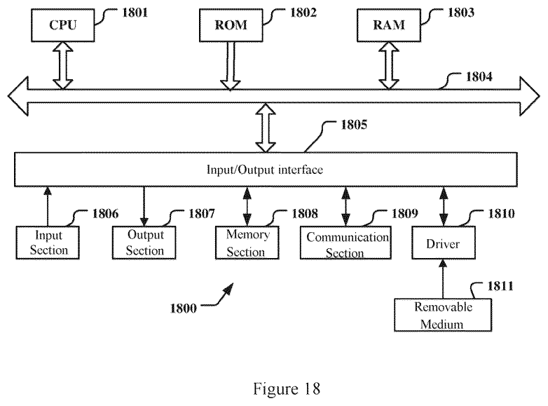

In the case where the present disclosure is realized with software or firmware, a program constituting the software is installed in a computer with a dedicated hardware structure (e.g. the general computer 1800 shown in FIG. 18) from a storage medium or network, wherein the computer is capable of implementing various functions when installed with various programs.

In FIG. 18, a central processing unit (CPU) 1801 executes various processing according to a program stored in a read-only memory (ROM) 1802 or a program loaded to a random access memory (RAM) 1803 from a memory section 1808. The data needed for the various processing of the CPU 1801 may be stored in the RAM 1803 as needed. The CPU 1801, the ROM 1802 and the RAM 1803 are linked with each other via a bus 1804. An input/output interface 1805 is also linked to the bus 1804.

The following components are linked to the input/output interface 1805: an input section 1806 (including keyboard, mouse and the like), an output section 1807 (including displays such as a cathode ray tube (CRT), a liquid crystal display (LCD), a loudspeaker and the like), a memory section 1808 (including hard disc and the like), and a communication section 1809 (including a network interface card such as a LAN card, modem and the like). The communication section 1809 performs communication processing via a network such as the Internet. A driver 1810 may also be linked to the input/output interface 1805, if needed. If needed, a removable medium 1811, for example, a magnetic disc, an optical disc, a magnetic optical disc, a semiconductor memory and the like, may be installed in the driver 1810, so that the computer program read therefrom is installed in the memory section 1808 as appropriate.

In the case where the foregoing series of processing is achieved through software, programs forming the software are installed from a network such as the Internet or a memory medium such as the removable medium 1811.

It should be appreciated by those skilled in the art that the memory medium is not limited to the removable medium 1811 shown in FIG. 18, which has program stored therein and is distributed separately from the apparatus so as to provide the programs to users. The removable medium 1811 may be, for example, a magnetic disc (including floppy disc (registered trademark)), a compact disc (including compact disc read-only memory (CD-ROM) and digital versatile disc (DVD), a magneto optical disc (including mini disc (MD) (registered trademark)), and a semiconductor memory. Alternatively, the memory medium may be the hard discs included in ROM 1802 and the memory section 1808 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a (n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
at least one processor; and
at least one memory including computer program code, where the at least one memory and the computer program code are configured, with the at least one processor, to cause the electronic apparatus:
determine that a physical layer beam management event has occurred; and
perform a beam management procedure initiated by user equipment.

2. The electronic apparatus according to claim 1, wherein, the beam management procedure initiated by the user equipment comprises any one or more of the following: beam sweeping initiated by the user equipment, beam reporting initiated by the user equipment, beam activation initiated by the user equipment, and beam selecting initiated by the user equipment.

3. The electronic apparatus according to claim 2, wherein, the at least one memory and the computer program code are further configured, with the at least one processor, to cause the electronic apparatus to request a network side to trigger the beam sweeping initiated by the user equipment via uplink control information or MAC CE.

4. The electronic apparatus according to claim 3, wherein the uplink control information or the MAC CE comprises information for triggering downlink beam sweeping,
wherein the uplink control information comprises information indicating an activated CSI-AperiodicTriggerState, and the MAC CE comprises information indicating an activated or a non-activated CSI-AperiodicTriggerState; or
wherein, the uplink control information or the MAC CE comprises information for triggering uplink beam sweeping,
wherein, the uplink control information or the MAC CE comprises aperiodicSRS-ResourceTrigger as the information for triggering uplink beam sweeping.

5. (canceled)

6. The electronic apparatus according to claim 4, wherein the at least one memory and the computer program code are further configured, with the at least one processor, to cause the electronic apparatus to obtain, from the network side, confirmation of the uplink beam sweeping by the network side.

7. The electronic apparatus according to claim 2, wherein the at least one memory and the computer program code are further configured, with the at least one processor, to cause the electronic apparatus to measure a reference signal received by the user equipment and perform the beam reporting initiated by the user equipment based on a measurement result,
wherein the reference signal comprises any one or more of the following: a synchronization signal block, a channel state information reference signal, and a demodulation reference signal.

8. (canceled)

9. The electronic apparatus according to claim 7, wherein in a case that the reference signal comprises a demodulation reference signal, the at least one memory and the computer program code are configured, with the at least one processor, to cause the electronic apparatus to report one of the following: a transmission configuration indicator state identification corresponding to the demodulation reference signal; an identification of a synchronization signal block or a channel state information reference signal comprised in the transmission configuration indicator state corresponding to the demodulation reference signal.

10. The electronic apparatus according to claim 2, wherein the at least one memory and the computer program code are configured, with the at least one processor, to cause the electronic apparatus to transmit information of a beam suggested by the user equipment in the beam activation initiated by the user equipment or in the beam selecting initiated by the user equipment.

11. The electronic apparatus according to claim 10, wherein, the information of the beam comprises a unified Transmission Configuration Indicator state which is capable of being used for both an uplink beam and a downlink beam: or
information of an uplink beam comprises a Transmission Configuration Indicator state, and information of a downlink beam comprises spatial relationship information.

12. The electronic apparatus according to claim 10, wherein the at least one memory and the computer program code are further configured, with the at least one processor, to cause the electronic apparatus to obtain, from the network side, information indicating a range of beams from which the user equipment suggests a beam.

13. The electronic apparatus according to claim 12, wherein the at least one memory and the computer program code are configured, with the at least one processor, to cause the electronic apparatus to receive, via MAC CE, information of adjustment on the range by the network side.

14. The electronic apparatus according to claim 10, wherein the at least one memory and the computer program code are further configured, with the at least one processor, to cause the electronic apparatus to: perform the transmission via uplink control information or MAC CE; and receive, from the network side, an acknowledgement ACK or non-acknowledgement NACK message for the transmission.

15. The electronic apparatus according to claim 14, wherein the at least one memory and the computer program code are configured, with the at least one processor, to cause the electronic apparatus to determine that the beam suggested by the user equipment is correctly received and approved by the network side, in a case of receiving an ACK message from the network side, or
wherein the at least one memory and the computer program code are configured, with the at least one processor, to cause the electronic apparatus to determine that the beam suggested by the user equipment is correctly received and approved by the network side, in a case of receiving an ACK message from the network side and receiving additional downlink control information indicating approval within a predetermined time window; or
wherein the at least one memory and the computer program code are configured, with the at least one processor, to cause the electronic apparatus to determine that the beam suggested by the user equipment is correctly received and accepted by the network side, in a case of receiving an ACK message from the network side and not receiving additional downlink control information within a predetermined time window.

16.-17. (canceled)

18. The electronic apparatus according to claim 10, wherein the at least one memory and the computer program code are further configured, with the at least one processor, to cause the electronic apparatus to receive a list of component carriers from the network side, wherein the beam suggested by the user equipment is applicable to each of the component carriers in the list.

19. The electronic apparatus according to claim 1, wherein
the at least one memory and the computer program code are further configured, with the at least one processor, to cause the electronic apparatus to receive, from a network side, an indication of whether to enable a beam management function initiated by the user equipment,
wherein the at least one memory and the computer program code are configured, with the at least one processor, to cause the electronic apparatus to receive the indication via radio resource control signaling.

20. (canceled)

21. An electronic apparatus for wireless communications, comprising:
at least one processor; and
at least one memory including computer program code, where the at least one memory and the computer program code are configured, with the at least one processor, to cause the electronic apparatus to:
receive indication information in a beam management procedure initiated by user equipment; and
perform beam management operations in response to the indication information.

22. The electronic apparatus according to claim 21, wherein the indication information comprises beam sweeping trigger information, and the at least one memory and the computer program code are configured, with the at least one processor, to cause the electronic apparatus to receive the beam sweeping trigger information from the user equipment via uplink control information or MAC CE.

23. The electronic apparatus according to claim 22, wherein the beam sweeping trigger information comprises information for triggering downlink beam sweeping, in a case that the information is received via uplink control information, the information comprises information indicating an activated CSI-AperiodicTriggerState, and in a case that the information is received via MAC CE, the information comprises information indicating an activated or a non-activated CSI-AperiodicTriggerState,
wherein the at least one memory and the computer program code are configured, with the at least one processor, to cause the electronic apparatus to: trigger beam sweeping of an aperiodic channel state information reference signal based on information of an activated CSI-AperiodicTriggerState, or activate a corresponding CSI-AperiodicTriggerState based on information of a non-activated CSI-AperiodicTriggerState and trigger the beam sweeping of an aperiodic channel state information reference signal; and/or
wherein the beam sweeping trigger information comprises information for triggering uplink beam sweeping, the information comprises aperiodicSRS-ResourceTrigger, and the at least one memory and the computer program code are configured, with the at least one processor, to cause the electronic apparatus to transmit a confirmation message to the user equipment in response to the information, to allow the user equipment to transmit an aperiodic sounding reference signal.

24.-26. (canceled)

27. The electronic apparatus according to claim 16, wherein the indication information comprises information of a beam suggested by the user equipment for beam activation or beam selecting,
wherein the at least one memory and the computer program code are configured, with the at least one processor, to cause the electronic apparatus to receive information of the beam from the user equipment via uplink control information or MAC CE, and transmit an acknowledgement ACK or non-acknowledgement NACK message with respect to reception of the information,
wherein in a case that the beam suggested by the user equipment is correctly received and approved by a network side, the at least one memory and the computer program code are configured, with the at least one processor, to cause the electronic apparatus to transmit an ACK message to the user equipment, or
wherein in a case that the beam suggested by the user equipment is correctly received and approved by a network side, the at least one memory and the computer program code are configured, with the at least one processor, to cause the electronic apparatus to transmit an ACK message to the user equipment and transmits additional downlink control information indicating approval within a predetermined time window, or
wherein in a case that the beam suggested by the user equipment is correctly received but not approved by a network side, the at least one memory and the computer program code are configured, with the at least one processor, to cause the electronic apparatus to transmit an ACK message to the user equipment and transmit additional downlink control information comprising information of a beam rewritten by the network side within a predetermined time window.

28.-37. (canceled)

38. A method for wireless communications, comprising:
determining that a physical layer beam management event has occurred; and
performing a beam management procedure initiated by user equipment.

39.-40. (canceled)
